(19) United States
(12) Patent Application Publication
(10) Pub. No.: US 2004/0102724 A1
(43) Pub. Date: May 27, 2004

(54) Muscular relaxation machine

(76) Inventor: Jean-Claude Hirt, La Massana (AD)

Correspondence Address: LAW OFFICES OF JACOBSON HOLMAN, PROFESSIONAL LIMITED LIABILITY COMPANY, 400 SEVENTH STREET, N. W., WASHINGTON, DC, 20004, US

(21) Appl. No.: 10/640,569

(22) Filed: Aug. 14, 2003

Related U.S. Application Data
(63) Continuation of application No. PCT/IB02/00465, filed on Feb. 11, 2002.

(30) Foreign Application Priority Data
Feb. 16, 2001 (ES) P200100359

(51) Int. Cl. A61H 1/00

(52) U.S. Cl. 601/35; 601/98; 601/104

(57) ABSTRACT

Characterised in that it includes a pair of supports (4) for the legs of the user, said supports (4) being movable so that they approach and move away from each other, and said supports (4) being associated with driving means. Said supports (4) are padded and mounted on a height-adjustable plate (3).

Said driving means comprise a motor, to the shaft of which the supports (4) are associated by means of a pair of connecting rods or a connecting rod and crank mechanism, so that operation of the motor causes joint movement of the supports (4), which move away from and approach each other alternately.

It permits a relaxation movement to be carried out without the intervention of any person.

This invention relates to a muscular relaxation machine which achieves relaxation of the musculature of the legs.

### BACKGROUND

It is very usual to see masseurs/euses carrying out massages on professional sportsmen/women in order to avoid muscle injuries when the latter have to make a prolonged effort.

A massage of this type consists in holding the legs by the ankles and moving the legs energetically together and apart, in such a way that the muscles move and relax.

This technique has the disadvantage of being excessively tiring, so that it can only be carried out by a person for a relatively short period of time.

FR2632867 discloses a versatile device which makes it possible, on the one hand, to carry out a scissor movements of the legs and, on the other hand, as a complement, a to-and-fro movement. The device comprises a support platform provided with elevation means supporting another platform equipped with means for fastening sideways guiding slides on which pivoting heelpieces are fastened. Each slide-heelpiece assembly is coupled via connecting rods to at least one gear-motor group located between slideways so that the slides driven by the gear-motor group, causes the closing together and separation of the legs in an horizontal or inclined plane, upwards or downwards.

U.S. Pat. No. 4,711,229 discloses a massaging apparatus for the lower extremities of the body, comprising means to produce a massaging perpendicular to the axis of the legs in a radial and oscillating motion, i.e. to induce an oscillation corresponding to the arc of a circle, and longitudinally to the axis of the legs.

*None of these prior art devices provide means adapted to massaging the lower extremities of the body while supported on the knees adapted to each user and with the supports of the end parts of the legs adapted to rotate around a horizontal shaft so that its position can be changed.

A first objective of this invention therefore consists in achieving a machine which carries out this type of massage automatically, without the intervention of a person.

The machine of this invention manages to resolve the aforesaid disadvantages, while providing other advantages which will be described below.

### DESCRIPTION Of THE INVENTION

The muscular relaxation machine of this invention is characterised in that it includes a pair of supports for the legs of the user, said supports being movable so that they approach and move away from each other, and said supports being associated with driving means.

Thanks to this characteristic, relaxation of the legs of the user can be carried out without the intervention of any specialist, thus achieving an improved relaxing action.

In order to be able to adjust to the needs of the user and achieve maximum comfort in the machine of this invention, said supports are mounted on a height-adjustable plate and can also be rotatable around a vertical shaft, as well as being padded.

According to a first embodiment, said driving means comprise a motor, with the shaft of which the supports are associated by means of connecting rods, so that the operation of the motor causes joint movement of the supports, moving apart from and approaching each other, alternately.

According to a second embodiment, said driving means comprise a motor associated with a connecting rod and crank mechanism, with the end of said connecting rod being linked with one of the supports, and with said driving means also including means of transmitting the movement from one support to the other.

Preferably, said means of transmission of the movement of one support to the other includes a belt.

Advantageously, said supports are al so rotatable around a horizontal shaft.

Also advantageously, the machine of this invention further includes means for altering the point of oscillation between the connecting rod and the crank.

### BRIEF DESCRIPTION OF THE FIGURES

For a better understanding of all that has been described in this specification, some drawings are attached which, solely by way of example, show a practical case of embodiment of the muscular relaxation machine of this invention.

In said drawings, FIG. 1 is a perspective view of the machine of this invention according to a first embodiment, with the supports placed in a separated position;

FIG. 2 is a perspective view of the machine of this invention according to a first embodiment, with the supports beside one another;

FIG. 3 is a schematic plan view of the means of driving the movement of said supports according to a first embodiment;

FIG. 5 is a perspective view of the machine of this invention according to the embodiment shown in FIG. 4, with the supports rotated through 180° with respect to the position of the previous figure; and

FIGS. 6 and 7 are side elevation views of the machine of this invention according to another embodiment in two different positions adapted to massage the legs of a user while he or she is lying on his or her stomach or on his or her back, respectively.

### DESCRIPTION OF A PREFERRED EMBODIMENT

As can be appreciated in FIG. 1, the muscular relaxation machine of this invention includes a pair of vertical bars 1 attached to the chassis 2 of the machine.

Between said vertical bars 1 is fitted a plate 3 whose height can be adjusted. Although setting of the position of this plate 3 can be carried out in any suitable manner, in the embodiment shown this is done by means of a pair of knobs situated on the ends of the plate 3.

The machine of this invention also includes a pair of supports 4 for the legs of the user. These supports 4 can be moved along two slots provided in the plate 3, so that they carry out an alternating movement of approaching and moving away from each other.

In order to permit maximum comfort of the user of the machine of this invention, said supports 4 are made of a padded material and can rotate around a vertical shaft.

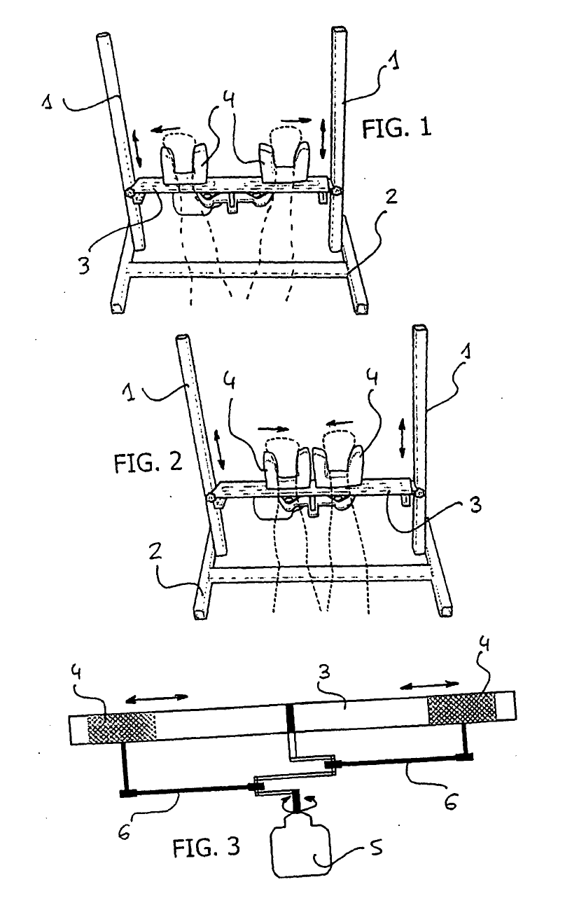

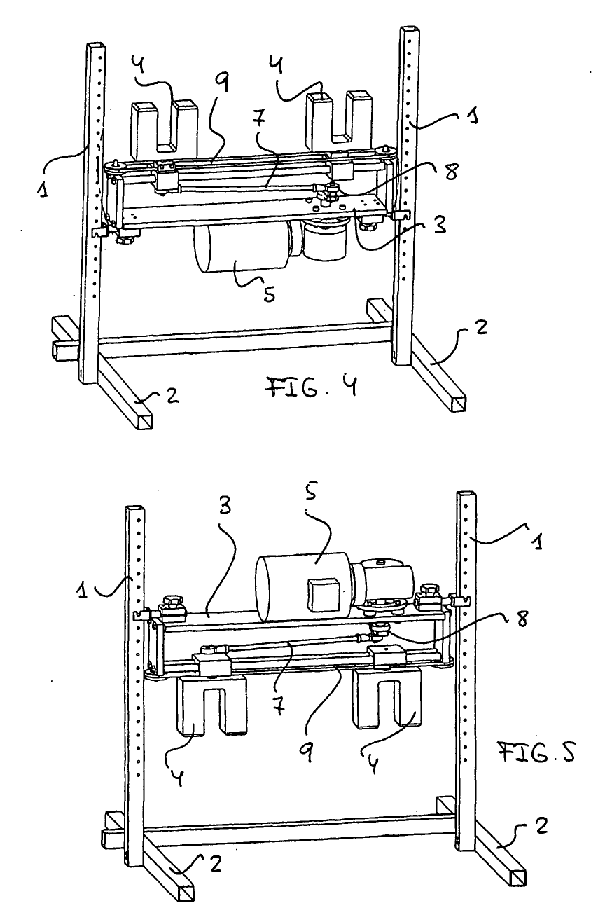

The movement of said supports 4 can be driven in any suitable manner. However, FIGS. 3 and 4 show two alternative embodiments of the driving means of the supports 4.

In accordance with the embodiment shown in FIG. 3, these driving means include a motor 5, with the shaft of which are associated a pair of connecting rods 6, one for each support 4. Rotation of the motor shaft 5 thus leads to alternating movement of the supports approaching and moving away from each other.

According to the embodiment shown in FIGS. 4 and 5, the driving means include a motor 5 associated with a connecting rod 8 and crank 8 mechanism. The end of said connecting rod 7 is linked to one of the supports 4, with said driving means also including a belt 9 which transmits the movement from one support 4 to the other.

The position of the supports 4 can also be changed to the position shown in FIG. 5, by rotating them around a horizontal shaft. In this position, the supports 4 are used for the knees.

If so wished, the point of oscillation between the connecting rod 7 and the crank 8 can be altered, thereby regulating the stroke of the oscillatory movement of the supports 4. Alteration of the point of oscillation is implemented through a number of orifices (not shown) provided along the length of the crank 8, with the end of the connecting rod attached into one of these orifices.

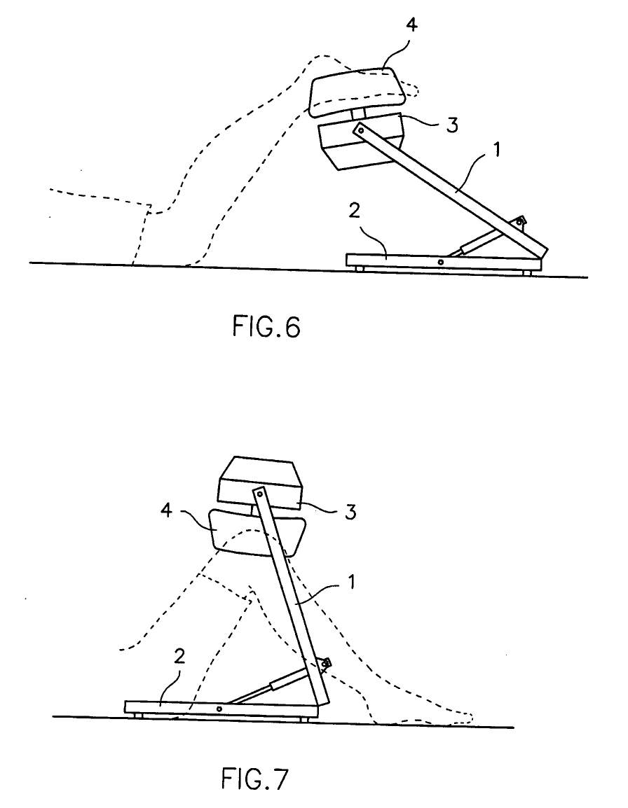

FIGS. 6 and 7 shows the machine of this invention according to an alternate embodiment wherein bars 1 are hinged so as to pivot about the chassis 2 and setting means are provided to set the bars 1 in a desired angle with respect to chassis 2. Plate 3 is fitted between the bars 1 and the driving means are enclosed in a housing attached to plate 3.

With the machine of this invention it is very simple to implement the desired relaxation movement. To that end, the user of the machine must first stretch out on the floor and place the feet on said supports 4. The user or the person supervising the relaxation movement then sets the height of the plate 3 so that the user obtains the maximum comfort, which can also be achieved thanks to the rotatory movement of the supports 4.

A massaging position where the user is lying on his or her stomach with his or her insteps on supports 4 is shown in FIG. 6. Another alternative massaging position is shown in FIG. 7, wherein the user is laying on his or her back and the supports 4 are in the inverted position shown in FIG. 5 to fit the user's knees. In still another alternative massaging position (not shown) the user is laying on his or her back with his or her heels on the supports 4, which are in the upright position. Other massaging positions not shown are possible.

Once in this position, the motor 5 will simply have to be run so that the supports 4 carry out the aforesaid movement, leading to relaxation of the legs of the user.

As is obvious, the motor can have control means associated with it in order to regulate, for example, the speed of movement of the supports 4 or the duration of said movement.

Despite the fact that reference has been made to a specific embodiment of the invention, it will be obvious to an expert in the subject that the muscular relaxation machine described allows of many variations and modifications, and that all the details mentioned may be replaced by others that are technically equivalent, without departing from the sphere of protection defined in the attached claims.

1. Muscular relaxation machine for relaxation of the leg muscles comprising:
a pair of supports (4) for the legs of the user, associated with driving means (5, 6, 7, 8) in order that said supports (4) being movable so that they approach and move away from each other; and
a height-adjustable plate (3) upholding said pair of supports (4);
wherein said pair of supports (4) are further rotatable around a horizontal shaft so that its position can be changed by appropriately rotating them to achieve a maximum comfort of the user and a massaging position for the legs and knees.

2. Muscular relaxation machine according to claim 1, wherein said supports (4) can move horizontally along slots provided in said plate (3).

3. Muscular relaxation machine, according to claim 1, wherein said height-adjustable plate (3) is rotatable around a horizontal axis and can be fixed in a suitable inclined position.

4. Muscular relaxation machine according to any of the previous claims, wherein said supports (4) are also rotatable around a vertical axis.

5. Muscular relaxation machine according to claim 1 wherein said supports (4) are padded.

6. Muscular relaxation machine according to claim 1, wherein said driving means comprise:
a motor (5); and
a crankshaft attached to a driving axis of said motor;
wherein each of said supports (4) is connected to said crankshaft by means of a connecting rod (6), so that the operation of the motor (5) causes joint movement of the supports (4) which approach and move away from each other.

7. Muscular relaxation machine according to claim 1, wherein said driving means comprise:
a motor (5);
a connecting rod (7) and crank (8) mechanism associated to said motor (5); and
means (9) for transmitting movement from one support (4) to the other,
wherein the end of said connecting rod (7) is linked with one of the supports (4).

8. Muscular relaxation machine according to claim 7, wherein said means of transmitting the movement of one support (4) to the other include a belt (9).

9. Muscular relaxation machine according to claim 7, wherein a number of orifices are provided along the length of said crank (8) with the end of said connecting rod (7) being attached into one of these orifices, in order to obtain a regulation of the stroke of the approach and move away movement of said supports (4).

10. Muscular relaxation machine according to any of the claims 7 to 9, wherein said supports (4) are adapted to receive end parts of said legs while them being supported on the ground or a support plane by the knees.
